(19) United States
(12) Patent Application Publication
(10) Pub. No.: US 2018/0208015 A1
(43) Pub. Date: Jul. 26, 2018

(54) SYSTEM AND METHOD FOR CONTROLLING TEMPERATURE OF VEHICLE

(71) Applicant: BOE TECHNOLOGY GROUP CO., LTD., Beijing (JP)

(72) Inventor: Bo ZHANG, Beijing (CN)

(73) Assignee: BOE TECHNOLOGY GROUP CO. LTD.

(21) Appl. No.: 15/568,077

(22) PCT Filed: May 10, 2017
(86) PCT No.: PCT/CN2017/083751

§ 371 Date: Oct. 20, 2017

(30) Foreign Application Priority Data
Jun. 30, 2016 (CN) 201610513410.5

(51) Int. Cl. B60H 1/00; H02S 99/00; H02S 20/32

(52) U.S. Cl. CPC B60H 1/00478; H02S 20/32; H02S 99/00; B60H 1/00878

(57) ABSTRACT

The present disclosure relates to a system for controlling a temperature of a vehicle. The system includes: a power supply device, a control device and a temperature adjusting device, wherein the temperature adjusting device is made of a semiconductor material, a first end of two ends of the temperature adjusting device is provided outside the vehicle and a second end of the two ends of the temperature adjusting device is provided inside the vehicle; and the control device is provided between the power supply device and the temperature adjusting device and configured to control a flowing direction of a current supplied by the power supply device between the two ends of the temperature adjusting device, such that the first end and the second end of the temperature adjusting device absorb heat or release heat respectively.

### CROSS-REFERENCE TO RELATED APPLICATIONS

The present application is based upon International Application No. PCT/CN2017/083751, filed on May 10, 2017, which is based upon and claims priority to Chinese Patent Application No. 201610513410.5, titled “SYSTEM AND METHOD FOR CONTROLLING TEMPERATURE OF VEHICLE” filed on Jun. 30, 2016, the entire contents of which are incorporated herein by reference.

### TECHNICAL FIELD

The present disclosure relates to the field of vehicle temperature control technology, and more particularly to a system and a method for controlling a temperature of a vehicle.

### BACKGROUND

When the weather is hot, the sunray will be very strong, and the temperature inside a vehicle will rise over time. Similarly, when the weather is cold, the temperature inside the vehicle will decrease over time. A high or low temperature inside the vehicle may affect a comfort level of a passenger. Therefore, it is necessary to control the temperature inside the vehicle.

In the prior art, there is a vehicle temperature control system including a cooling assembly, a heating assembly, a control assembly and a purification assembly. The cooling assembly uses a refrigerant to reduce the temperature inside the vehicle under the control of the control assembly. The heating assembly improves the temperature inside the vehicle under the control of the control assembly. The purification assembly speeds up air circulation inside the vehicle under the control of the control assembly. The cooling assembly, the heating assembly and the purification assembly cooperate to control the temperature of the vehicle. Besides, the purification assembly may also be used to purify the air.

However, the above-mentioned vehicle temperature control system is large and needs complex pipeline network, therefore, the structure is complex and the cost is high.

### SUMMARY

The present disclosure relates to a system and a method for controlling a temperature of a vehicle.

There is provided a system for controlling a temperature of a vehicle, including: a power supply device, a control device and a temperature adjusting device, wherein the temperature adjusting device is made of a semiconductor material, a first end of two ends of the temperature adjusting device is provided outside the vehicle and a second end of the two ends of the temperature adjusting device is provided inside the vehicle; and the control device is provided between the power supply device and the temperature adjusting device and configured to control a flowing direction of a current supplied by the power supply device between the two ends of the temperature adjusting device, such that the first end and the second end of the temperature adjusting device absorb heat or release heat respectively.

Another aspect of the present disclosure provides a method for controlling a temperature of a vehicle, including: providing a temperature adjusting device made of a semiconductor material in the vehicle, such that a first end of two ends of the temperature adjusting device is provided outside the vehicle and a second end of two ends of the temperature adjusting device is provided inside the vehicle; and controlling a flowing direction of a current supplied to the temperature adjusting device between the two ends of the temperature adjusting device, such that the first end and the second end of the temperature adjusting device absorb heat or release heat respectively.

It is to be understood that both the foregoing general description and the following detailed description are exemplary and explanatory only and are not restrictive of the present disclosure.

### BRIEF DESCRIPTION OF THE DRAWINGS

In order to more clearly illustrate the technical solution in the embodiments of the present disclosure, the drawings to be used in the description of the embodiments will be briefly described below. It will be apparent that the drawings in the following description are merely some embodiments of the present disclosure. Other drawings may be obtained by those skilled in the art based on these drawings without paying for creative labor.

FIG. 1A is a schematic structural view of a system for controlling a temperature of a vehicle according to an embodiment of the present disclosure;

FIG. 1B is a schematic structural view of a temperature adjusting device according to an embodiment of the present disclosure;

FIG. 2 is a schematic structural view of a system for controlling a temperature of a vehicle according to another embodiment of the present disclosure;

FIG. 3A is a schematic diagram of an operation of a system for controlling a temperature of a vehicle according to an embodiment of the present disclosure;

FIG. 3B is a schematic diagram of an operation of a system for controlling a temperature of a vehicle according to an embodiment of the present disclosure;

FIGS. 4A to 4C are schematic structural views of solar panels according to embodiments of the present disclosure;

FIG. 4D is a schematic view of a solar energy sheet being folded of a solar panel according to an embodiment of the present disclosure; and

FIG. 5 is a schematic view of a system for controlling a temperature of a vehicle disposed on a vehicle according to an embodiment of the present disclosure.

Through the above drawings, specific embodiments of the present disclosure have been shown, which will be described in more detail later. The drawings and text description are not intended to limit the scope of concept of the present disclosure in any way, but rather to teach those skilled in the art, by reference to specific embodiments, the concepts of the present disclosure.

### DETAILED DESCRIPTION

In order to make the objects, technical solutions and advantages of the present disclosure clearer, the implementations of the present disclosure will be described in more detail in combination with the accompanying drawings.

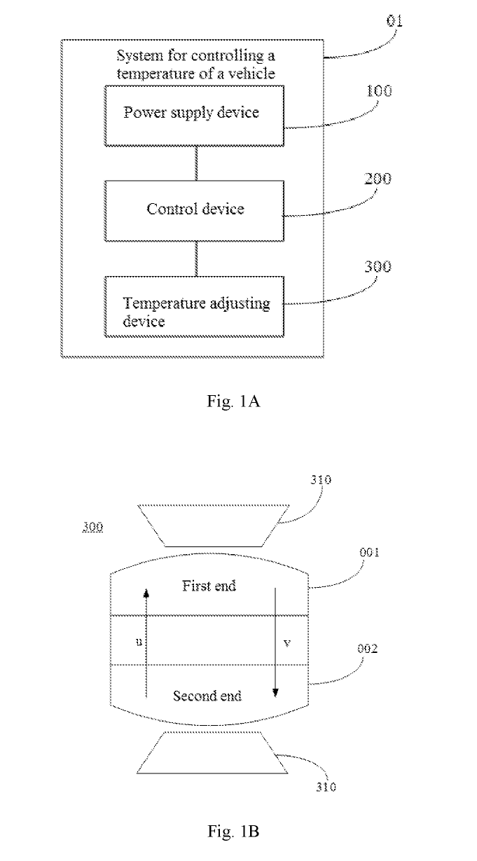

As shown in FIG. 1A, an embodiment of the present disclosure provides a system 01 for controlling a temperature of a vehicle including: a power supply device 100, a control device 200 and a temperature adjusting device 300.

The temperature adjusting device 300 is made of a semiconductor material. A first end of two ends of the temperature adjusting device 300 is provided outside the vehicle, and a second end of the two ends of the temperature adjusting device 300 is provided inside the vehicle.

The control device 200 is provided between the power supply device 100 and the temperature adjusting device 300. The control device 200 is configured to control a flowing direction of a current supplied by the power supply device 100 between the two ends of the temperature adjusting device 300, such that the temperature adjusting device 300 realizes cooling or heating, for example, such that the first end and the second end of the temperature adjusting device 300 absorb heat or release heat respectively.

To sum up, in the system for controlling a temperature of a vehicle provided by the embodiment of the present disclosure, since the temperature adjusting device of the system is made of a semiconductor material, a first end of two ends of the temperature adjusting device is provided outside the vehicle and a second end of the two ends of the temperature adjusting device is provided inside the vehicle, the control device of the system is capable of controlling a flowing direction of a current supplied by the power supply device between the two ends of the temperature adjusting device, such that the temperature adjusting device may realize cooling or heating, which simplifies the structure of the vehicle temperature control system and reduces the cost compared with the prior art.

It should be noted that, after a circuit having a semiconductor material is connected to a DC power supply, energy of the semiconductor material will be transferred. Specifically, when the current flowing through the semiconductor material flows from one end (e.g., end a) of the semiconductor material to the other end (e.g., end b), the end a will absorb heat to become a cold end while the end b will release heat to become a hot end. Similarly, when the current flows from the end b to the end a, the end b will absorb the heat to become the cold end, while the end a will release the heat to become the hot end. Therefore, since the end a and the end b absorb or release heat respectively, the heat is transferred from the interior of the vehicle to the exterior of the vehicle (cooling) or transferred from the exterior of the vehicle to the interior of the vehicle (heating). FIG. 1B shows a schematic structural view of the temperature adjusting device 300. Since the first end 001 of the temperature adjusting device 300 is provided outside the vehicle and the second end 002 is provided inside the vehicle, the second end 002 realizes cooling when the current flowing through the temperature adjusting device 300 flows from the second end 002 to the first end 001 (the flowing direction of the current is indicated by u), in this way, fit and cool riding environment is provided for the passenger when the weather is hot. The second end 002 realizes heating when the current flowing through the temperature adjusting device 300 flows from the first end 001 to the second end 002 (the flowing direction of the current is indicated by v), in this way, warm and comfortable riding environment is provided for the passenger when the weather is cold. The temperature adjusting device of the embodiment of the present disclosure is made of a semiconductor material, and a temperature adjusting device replaces the separate cooling assembly and the heating assembly in the prior art. The control device controls the flowing direction of a current supplied by the power supply device between two ends of the temperature adjusting device, such that the temperature adjusting device realizes cooling or heating.

Further, as shown in FIG. 1B, at least one of the first end and the second end of the temperature adjusting device 300 is provided with a heat sink 310. That is, the first end of the temperature adjusting device 300 is provided with the heat sink, or the second end of the temperature adjusting device 300 is provided with a heat sink, or both the first end and the second end of the temperature adjusting device 300 are provided with the heat sink. The heat sink is advantageous in enhancing the effect of cooling or heating of the temperature adjusting device, thereby accelerating the speed of cooling or heating the interior of the vehicle. For example, the heat sink may be a heat dissipating fin or a fan.

Further, the control device is further configured to change a magnitude of the current output to the temperature adjusting device. When the magnitude of the current of the temperature adjusting device changes, the temperature adjusting device will adjust the current cooling temperature or heating temperature inside the vehicle, i.e., enhancing or weakening the cooling effect, or enhancing or weakening the heating effect. By way of example, it is assumed that the current supplied by the power supply device flows from the second end of the temperature adjusting device to the first end at the current time (i.e., the second end inside the vehicle is cooled), the magnitude of the current is x1 and the temperature inside the vehicle is 26. If the magnitude of the current becomes x2 (x2 is less than x1), the temperature adjusting device will weaken the cooling effect, and then the temperature inside the vehicle will be higher than 26 degrees. If the magnitude of the current becomes x3 (x3 is greater than x1), the temperature adjusting device will enhance the cooling effect, and then the temperature inside the vehicle will be lower than 26 degrees. By way of example, it is assumed that the current supplied by the power supply device flows from the first end of the temperature adjusting device to the second end at the current time (i.e., the second end inside the vehicle is heated), the magnitude of the current is y1 and the temperature inside the vehicle is 18. If the magnitude of the current becomes y2 (y2 is less than y1), the temperature adjusting device will weaken the heating effect, and then the temperature inside the vehicle will be lower than 18 degrees. If the magnitude of the current becomes y3 (y3 is greater than y1), the temperature adjusting device will enhance the heating effect, and then the temperature inside the vehicle will be higher than 18 degrees. That is, the system for controlling the temperature of the vehicle provided by the embodiment of the present disclosure may not only control the flowing direction of current between two ends of the temperature adjusting device, so that the temperature adjusting device realize cooling or heating to switch cooling and heating inside the vehicle, thereby obtaining the effect of controlling the temperature inside the vehicle, but also it may change the magnitude of the current output to the temperature adjusting device, such that the temperature adjusting device further adjusts the temperature inside the vehicle in the state of cooling or heating.

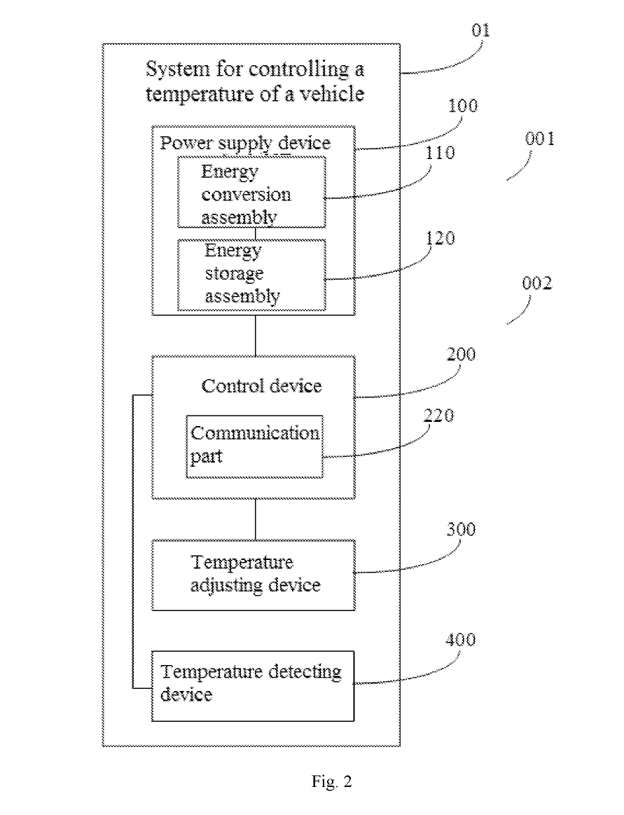

Further, as shown in FIG. 2, the system 01 further includes a temperature detecting device 400 provided within the vehicle.

The temperature detecting device 400 is electrically connected to the control device 200 and configured to detect a temperature inside the vehicle. By way of example, the temperature detecting device is a temperature sensor.

The control device 200 is configured to, when the temperature inside the vehicle detected by the temperature detecting device 400 reaches a preset temperature threshold, control the power supply device 100 to stop supplying the current to the temperature adjusting device 300, or reduce the magnitude of the current supplied by the power supply device 100 to the temperature adjusting device 300 by a current adjusting circuit (not shown in FIG. 2) provided in the control device 200. By way of example, the current adjusting circuit may include a field effect transistor or a sliding rheostat or the like, and the effect of reducing the magnitude of the current supplied from the power supply device to the temperature adjusting device may be achieved by the field effect transistor or the sliding rheostat. The circuit structure of the current adjusting circuit may be referred to the prior art, which is not limited by the embodiment of the present disclosure. The temperature detecting device in the embodiment of the present disclosure is capable of detecting the temperature inside the vehicle in real time and transmitting the detected temperature to the control device in real time. When the temperature detected by the temperature detecting device reaches the preset temperature threshold, the control device may cut off the power supply and control the power supply device to stop supplying the current to the temperature adjusting device, such that the temperature adjusting device stops the cooling or heating. Alternatively, the control device may reduce the magnitude of the current supplied by the power supply device to the temperature adjusting device through a current adjusting circuit provided in the control device, to weaken the cooling effect or heating effect, so as to provide the passenger comfortable riding environment with a stable temperature. In the embodiment of the present disclosure, the system for controlling the temperature of the vehicle is used together with the temperature detecting device, to realize the effect of controlling and adjusting the temperature inside the vehicle in time. As an example, when the second end of the temperature adjusting device is cooled, the temperature detecting device detects that the temperature inside the vehicle is 26 degrees at the current time, and the preset temperature threshold is 26 degrees. At this time, the control device may prohibit inputting the current to the temperature adjusting device.

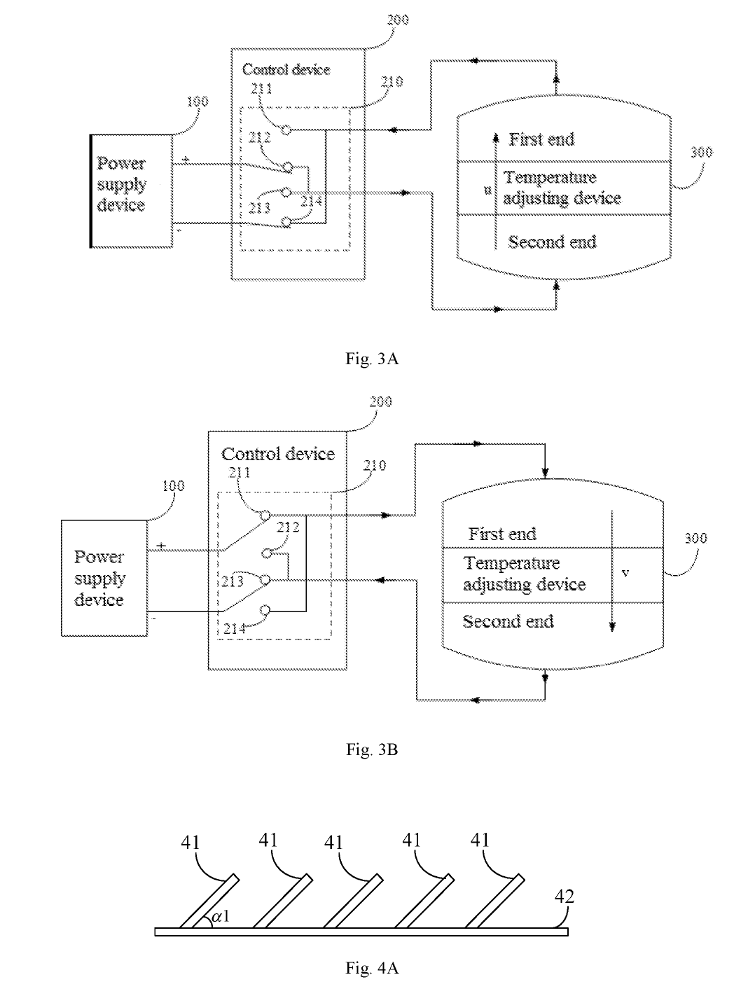

Optionally, as shown in FIG. 3A, the control device 200 includes a positive and negative electrode switching circuit 210. The positive and negative electrode switching circuit 210 is configured to control a positive electrode (+) of the power supply device 100 to be connected to the second end of the temperature adjusting device 300 and a negative electrode (−) of the power supply device 100 to be connected to the first end of the temperature adjusting device 300 when a cooling instruction is received, so that the current provided by the power supply device 100 is flowed from the second end to the first end. As shown in FIG. 3A, the positive and negative electrode switching circuit 210 is provided with a first contact 211, a second contact 212, a third contact 213 and a fourth contact 214. Specifically, when the cooling instruction is received, the second contact 212 of the positive and negative electrode switching circuit 210 is connected to the positive electrode of the power supply device 100, and the fourth contact 214 is connected to the negative electrode of the power supply device 100, such that the positive electrode of the power supply device 100 is connected to the second end of the temperature adjusting device 300, and the negative electrode of the power supply device 100 is connected to the first end of the temperature adjusting device 300. In this way, the current of the power supply device 100 is output from the positive electrode, flowed to the second end of the temperature adjusting device 300 and then output from the first end of the temperature adjusting device 300, and finally input into the negative electrode of the power supply device 100. The flowing direction of the current between the two ends of the temperature adjusting device 300 is a direction indicated by u. The second end inside the vehicle is cooled, and the system for controlling the temperature of the vehicle realizes the cooling effect.

Similarly, as shown in FIG. 3B, the positive and negative electrode switching circuit 210 is configured to: control a positive electrode (+) of the power supply device 100 to be connected to the first end of the temperature adjusting device 300 and a negative electrode of the power supply device 100 to be connected to the second end of the temperature adjusting device 300 when a heating instruction is received, so that the current provided by the power supply device 100 is flowed from the first end to the second end. Specifically, when the heating instruction is received, the first contact 211 of the positive and negative electrode switching circuit 210 is connected to the positive electrode of the power supply device 100, and the third contact 213 is connected to the negative electrode of the power supply device 100, such that the positive electrode of the power supply device 100 is connected to the first end of the temperature adjusting device 300, and the negative electrode of the power supply device 100 is connected to the second end of the temperature adjusting device 300. In this way, the current of the power supply device 100 is output from the positive electrode, flowed to the first end of the temperature adjusting device 300 and then output from the second end of the temperature adjusting device 300, and finally input into the negative electrode of the power supply device 100. The flowing direction of the current between the two ends of the temperature adjusting device 300 is a direction indicated by v. The second end inside the vehicle is heated, and the system for controlling the temperature of the vehicle achieves the heating effect.

When the cooling instruction or the heating instruction is received, the control device of the embodiment of the present disclosure may switch the positive and negative electrodes of the power supply interface of the power supply device through the positive and negative electrode switching circuit, so that the flowing direction of the current supplied by the power supply device between two ends of the temperature adjusting device may be controlled. It should be noted that the cooling instruction or the heating instruction may be an instruction triggered by the passenger directly using the control device or may be an instruction sent by the user to the control device through a mobile terminal. The embodiment of the present disclosure is not limited thereto.

Further, as shown in FIG. 2, the power supply device 100 includes: an energy conversion assembly 110 configured to collect environmental energy and convert the environmental energy into electrical energy. It should be noted that, in the system for controlling the temperature of the vehicle in the prior art, power for controlling the temperature inside the vehicle all comes from an engine of the vehicle. When the system for controlling the temperature of the vehicle operates, 8% to 12% of the total power of the engine will be generally consumed, among which, power consumed by a refrigeration compressor in a cooling assembly is about 80% to 85%, and power consumed by the fan is about 15% to 20%, which results in a large load on the engine. In addition, a refrigerant is required when the system for controlling the temperature of the vehicle operates for cooling, but the use of the refrigerant not only increases the temperature control cost, but also speeds up the consumption of ozone, which damages and pollutes the environment and endangers human health. However, the energy conversion assembly in the embodiment of the present disclosure is capable of collecting environmental energy and converting the environmental energy into electrical energy, which does not consume engine power, reduces the load on the engine, without damaging and polluting environment and without endangering human health. As an example, the environmental energy may be wind energy, solar energy, etc., and there is no limit on the type of environmental energy in the embodiment of the present disclosure. Herein, for example, the environmental energy is solar energy. Since the solar energy is renewable energy, the use of solar energy as operating power of the vehicle temperature control system not only reduces the load on the engine, but also greatly reduces the temperature control cost. At the same time, since the solar energy is clean and pollution-free energy, the use of solar energy as operating power of the vehicle temperature control system avoids the vehicle temperature control system from polluting and damaging the environment, and avoids the vehicle temperature control system from harming the human health.

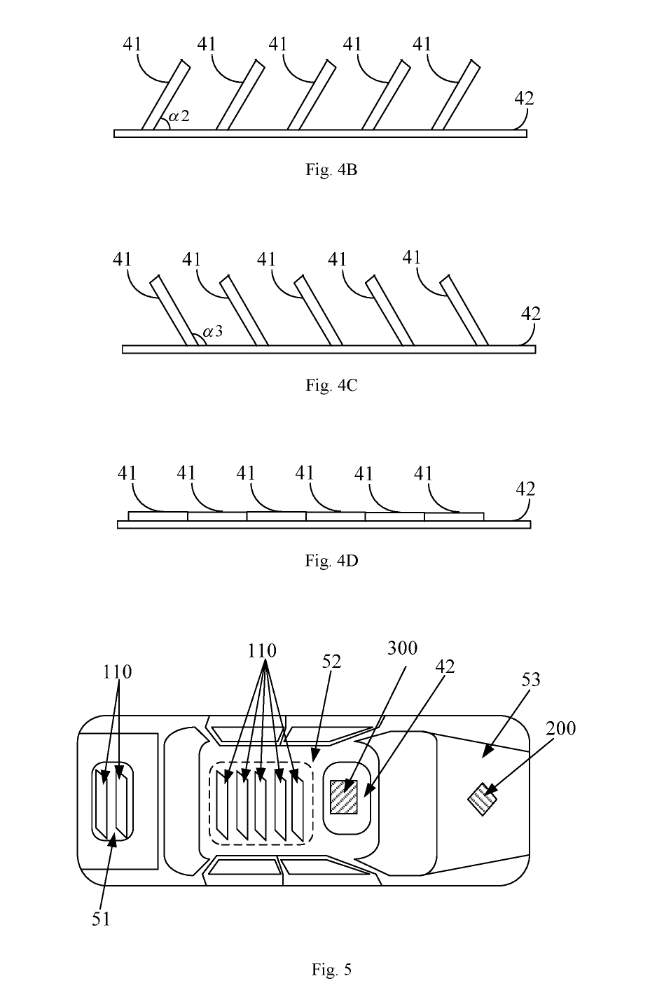

Optionally, the energy conversion assembly is a solar panel. As shown in FIG. 4A, the solar panel includes a plurality of solar energy sheets 41 arranged in an array. Each of the solar energy sheets 41 is provided with a light intensity sensor (not shown in FIG. 4A). The light intensity sensor is configured to detect a light intensity and control the solar energy sheet 41 in which the light intensity sensor is located to be rotated to a position with a largest light intensity by following an irradiation direction of sunlight. In this way, the energy conversion assembly may obtain more light and then obtain more electrical energy for the use of the temperature adjusting device. For example, FIGS. 4A to 4C show schematic views in which the plurality of solar energy sheets 41 is rotated to different positions by following the irradiation direction of the sunlight. In the embodiment, 42 in FIGS. 4A to 4C may be a sunroof of the vehicle, and angles between the solar energy sheets 41 and the sunroof 42 shown in FIGS. 4A to 4C are α1, α2, α3, respectively, wherein α1<α2<α3. In addition, when there is no light, as shown in FIG. 4D, the plurality of solar energy sheets 41 will be folded to contact the sunroof 42 and be in parallel with the same.

Optionally, the energy conversion assembly may be provided on a roof, a sunroof or a rear spoiler of the vehicle. For example, when the energy conversion assembly is the solar panel, the solar panel may get more light by disposing the energy conversion assembly on the roof, the sunroof or the rear spoiler of the vehicle, and then more electrical energy may be obtained for the use of the temperature adjusting device. In addition, the solar panel may be simultaneously provided on the roof and sunroof, alternatively, simultaneously provided on the sunroof and rear spoiler, alternatively, simultaneously provided on the roof and rear spoiler. In addition, when the energy conversion assembly is a solar panel, the energy conversion assembly may further be provided at other locations of the vehicle with more sunshine, such as a rear window of the vehicle.

Optionally, the energy conversion assembly may be fabricated on the sunroof using a thin film process. By using the thin film process to fabricate the energy conversion assembly (for example, the solar panel) on the sunroof of the vehicle, it allows the energy conversion assembly to better absorb scattered light, thereby enabling the energy conversion assembly to better collect solar energy. At the same time, the thin film process is suitable for integrated manufacturing, and the appearance of the sunroof is relatively beautiful by fabricating the energy conversion assembly on the sunroof of the vehicle using the thin film process. The specific process of the thin film process may be referred to the prior art, which will not be repeated in the embodiments of the present disclosure herein.

It should be noted that, since the temperature adjusting device provided by the embodiment of the present disclosure is made of a semiconductor material and the power consumption of the semiconductor material is low, the power consumption of the temperature adjusting device is low. Therefore, when the energy conversion assembly is the solar panel, the electrical energy provided by the solar panel may meet the electricity demand of the vehicle temperature control system under non-extreme weather conditions.

Further, in order to allow the temperature adjusting device to operate for a long time, the electrical energy converted by the energy conversion assembly may also be stored. Optionally, as shown in FIG. 2, the power supply device 100 may further include: an energy storage assembly 120.

The energy storage assembly 120 is connected to the energy conversion assembly 110 and configured to store the electrical energy converted by the energy conversion assembly 110. The energy storage assembly 120 stores the electrical energy converted by the energy conversion assembly 110 and supplies the stored electrical energy to the temperature adjusting device 300 through the control device 200.

When the weather is hot, a temperature inside the vehicle will rise over time, and when the weather is cold, the temperature inside the vehicle will decrease over time, so when the passenger enters the vehicle and then starts the vehicle temperature control system, the passenger needs to wait for a period of time to enjoy the comfortable and pleasant temperature and environment. In order to allow the passenger to enjoy the comfortable and pleasant temperature and environment just upon entering the vehicle, the passenger may control the vehicle temperature control system remotely through a mobile terminal within a preset time period before entering the vehicle. Specifically, a control instruction may be sent to the vehicle temperature control system through a mobile terminal equipped with a control application (which controls the vehicle temperature control system), such that the vehicle temperature control system may realize cooling or heating in advance. In addition, the passenger may also send the control instruction to the vehicle temperature control system through the mobile terminal before entering the vehicle, such that the vehicle temperature control system stops cooling or heating. In addition, the passenger may also send the control instruction to the vehicle temperature control system through the mobile terminal before entering the vehicle, such that the vehicle temperature control system adjusts the current cooling temperature or heating temperature inside the vehicle. Optionally, as shown in FIG. 2, the control device 200 includes: a communication part 220. The communication part 220 is configured to receive a control instruction sent from a mobile terminal. By way of example, the control instruction may be used to instruct the control device to input a current to the temperature adjusting device, so as to start cooling or heating by the temperature adjusting device. The control instruction may also be used to instruct the control device to prohibit inputting the current to the temperature adjusting device, so that the temperature adjusting device stops cooling or heating. In addition, the control instruction may further be used to instruct the control device to change the magnitude of the current output to the temperature adjusting device, such that the temperature adjusting device adjusts the current cooling temperature or heating temperature inside the vehicle. Since the vehicle is exposed to light outdoors for a long period of time, the energy storage assembly may store a large amount of electrical energy. With the communication part, the passenger outside the vehicle may control the operating state of the temperature adjusting device by using the large amount of electrical energy stored in energy storage assembly in advance through the mobile terminal, and then the passenger may enjoy the green and comfortable riding environment timely.

The temperature adjusting device may be provided separately or may be integrated into the vehicle body. For example, the temperature adjusting device may be provided at an inner side of an air conditioning outlet inside the vehicle. The cooling temperature or heating temperature of the temperature adjusting device may be quickly diffused into the vehicle by an air conditioner, so that the temperature inside the vehicle may be rapidly adjusted and controlled. Alternatively, since the temperature adjusting device may be made to be quite thin, the temperature adjusting device may be further provided on a roof cover of the vehicle and integrated with the roof cover of the vehicle. In this way, an inner surface of the roof cover of the vehicle has both the cooling function and heating function. In addition, the temperature adjusting device may be further provided at other positions of the vehicle, such as the sunroof of the vehicle.

Optionally, the temperature adjusting device and the energy conversion assembly may be integrated on a roof, a sunroof or a rear spoiler of the vehicle. The light intensity of positions where the roof, the sunroof and the rear spoiler or the like are located is larger than that of the other positions of the vehicle, so that the temperature adjusting device and the energy conversion assembly are integrated on these inherent components of the vehicle, converting the solar energy directly into electrical energy in real time for the use by the temperature adjusting device.

As an example, FIG. 5 shows a schematic diagram of an arrangement of a temperature adjusting device, an energy conversion assembly (e.g., a solar panel) and a control device on the vehicle. In the embodiment, the temperature adjusting device 300 may be provided on the sunroof 42. A first end of the temperature adjusting device 300 is provided outside the vehicle, and a second end of the temperature adjusting device 300 is provided inside the vehicle. The energy conversion assembly 110 may be provided on the rear window 51 and the roof 52 of the vehicle, so as to obtain more light. The control device 200 may be provided on an engine cover 53.

The system for controlling the temperature of the vehicle provided by the embodiment of the present disclosure is an intelligent temperature control system. Compared with the vehicle temperature control system in the prior art, the structure of the vehicle temperature control system provided by the embodiment of the present disclosure is simpler, the cost is lower, and the load on the vehicle engine is reduced. When the temperature inside the vehicle is controlled and adjusted by using the vehicle temperature control system provided by the embodiments of the present disclosure, the cost is lower, and it will not pollute the environment, will not damage the environment or harm the human health.

The embodiment of the present disclosure also provides a vehicle temperature control method which utilizes the semiconductor temperature adjusting device 300 in the foregoing embodiment to control the temperature inside the vehicle.

In particular, in an embodiment, a method for controlling a temperature of a vehicle includes: providing a temperature adjusting device made of a semiconductor material in the vehicle, such that a first end of two ends of the temperature adjusting device is provided outside the vehicle and a second end of the two ends of the temperature adjusting device is provided inside the vehicle; and controlling a flowing direction of a current supplied to the temperature adjusting device between the two ends of the temperature adjusting device, such that the first end and the second end of the temperature adjusting device absorb heat or release heat respectively.

In another embodiment, the method for controlling a temperature of a vehicle further includes: controlling a magnitude of the current supplied to the temperature adjusting device.

In another embodiment, the method for controlling a temperature of a vehicle further includes: detecting a temperature inside the vehicle; and stopping supplying the current to the temperature adjusting device, or reducing the magnitude of the current supplied by the power supply device to the temperature adjusting device, when the temperature inside the vehicle reaches a preset temperature threshold.

More specific details of the method for controlling a temperature of a vehicle according to the present disclosure may be referred to the detailed description of the system for controlling a temperature of a vehicle described above, which will not be repeated herein.

To sum up, in a system for controlling a temperature of a vehicle provided by the embodiment of the present disclosure, since the temperature adjusting device of the system is made of a semiconductor material, a first end of two ends of the temperature adjusting device is provided outside the vehicle and a second end of the two ends of the temperature adjusting device is provided inside the vehicle, the control device of the system is capable of controlling a flowing direction of a current supplied by the power supply device between the two ends of the temperature adjusting device, such that the temperature adjusting device realizes cooling or heating. Compared with the prior art, it simplifies the structure of the vehicle temperature control system, reduces the cost, reduces the load on the vehicle engine, avoids the pollution and damage to the environment, avoids the harm to human health and reduces the temperature control cost.

The foregoing is only a preferable embodiment of the present disclosure and is not intended to limit the present disclosure. Any modifications, equivalent substitutions, improvements, and the like within the spirit and principle of the present disclosure are intended to fall within the protection scope of the present disclosure.

1. A system for controlling a temperature of a vehicle, comprising: a power supply device, a control device and a temperature adjusting device,
wherein the temperature adjusting device is made of a semiconductor material, a first end of two ends of the temperature adjusting device is provided outside the vehicle and a second end of the two ends of the temperature adjusting device is provided inside the vehicle; and
the control device is provided between the power supply device and the temperature adjusting device and configured to control a flowing direction of a current supplied by the power supply device between the two ends of the temperature adjusting device, such that the first end and the second end of the temperature adjusting device absorb heat or release heat respectively.

2. The system according to claim 1, wherein
the control device is further configured to change a magnitude of the current output to the temperature adjusting device.

3. The system according to claim 2, further comprising a temperature detecting device provided within the vehicle, wherein
the temperature detecting device is electrically connected to the control device and configured to detect a temperature inside the vehicle; and
the control device is configured to perform one of controlling the power supply device to stop supplying the current to the temperature adjusting device, and reducing the magnitude of the current supplied by the power supply device to the temperature adjusting device through a current adjusting circuit provided in the control device, when the temperature inside the vehicle detected by the temperature detecting device reaches a preset temperature threshold.

4. The system according to claim 1, wherein the control device comprises a positive and negative electrode switching circuit configured to:
control a positive electrode of the power supply device to be connected to the second end and a negative electrode of the power supply device to be connected to the first end when a cooling instruction is received, so that the current provided by the power supply device is flowed from the second end to the first end; and
control the positive electrode of the power supply device to be connected to the first end and the negative electrode of the power supply device to be connected to the second end when a heating instruction is received, so that the current provided by the power supply device is flowed from the first end to the second end.

5. The system according to claim 1, wherein the power supply device comprises: an energy conversion assembly configured to collect environmental energy and to convert the environmental energy into electrical energy.

6. The system according to claim 5, wherein the power supply device further comprises:
an energy storage assembly connected to the energy conversion assembly and configured to store the electrical energy converted by the energy conversion assembly.

7. The system according to claim 6, wherein the control device comprises: a communication part configured to receive a control instruction sent from a mobile terminal.

8. The system according to claim 1, wherein
at least one of the first end and the second end is provided with a heat sink; and
the heat sink is a heat dissipating fin or a fan.

9. The system according to claim 5, wherein the energy conversion assembly is a solar panel,
wherein the solar panel comprises a plurality of solar energy sheets arranged in an array, each of the solar energy sheets is provided with a light intensity sensor, the light intensity sensor is configured to detect a light intensity and control the solar energy sheet in which the light intensity sensor is located to be rotated to a position with a largest light intensity by following an irradiation direction of sunlight.

10. The system according to claim 1, wherein
the temperature adjusting device is provided at an inner side of an air conditioning outlet inside the vehicle.

11. The system according to claim 9, wherein the energy conversion assembly is provided on at least one of a roof, a sunroof and a rear spoiler of the vehicle.

12. The system according to claim 11, wherein the energy conversion assembly is fabricated on the sunroof using a thin film process.

13. The system according to claim 5, wherein the temperature adjusting device and the energy conversion assembly are integrated on at least one of a roof, a sunroof and a rear spoiler of the vehicle.

14. A method for controlling a temperature of a vehicle, comprising:
providing a temperature adjusting device made of a semiconductor material in the vehicle, such that a first end of two ends of the temperature adjusting device is provided outside the vehicle and a second end of the two ends of the temperature adjusting device is provided inside the vehicle; and
controlling a flowing direction of a current supplied to the temperature adjusting device between the two ends of the temperature adjusting device, such that the first end and the second end of the temperature adjusting device absorb heat or release heat respectively.

15. The method according to claim 14, further comprising:
controlling a magnitude of the current supplied to the temperature adjusting device.

16. The method according to claim 14, further comprising:
detecting a temperature inside the vehicle; and
stopping supplying the current to the temperature adjusting device, or reducing the magnitude of the current supplied by the power supply device to the temperature adjusting device, when the temperature inside the vehicle reaches a preset temperature threshold.

17. The system according to claim 1, wherein the temperature adjusting device is provided on a roof cover of the vehicle.
